(19) United States
(12) Patent Application Publication
(10) Pub. No.: US 2021/0103971 A1
(43) Pub. Date: Apr. 8, 2021

(54) DYNAMIC DISPLAY OF PRODUCT FEATURES RELATED TO CUSTOMER RELEVANT PREFERENCES

(71) Applicant: International Business Machines Corporation, Armonk, NY (US)

(72) Inventors: Jeremy R. Fox, Georgetown, TX (US); Zachary A. Silverstein, Jacksonville, FL (US); Raghuveer Prasad Nagar, Kota (IN); Peter Edward Stubbs, Georgetown, MA (US)

(21) Appl. No.: 16/595,611

(22) Filed: Oct. 8, 2019

(51) Int. Cl. G06Q 30/06; G06F 16/9535; G06N 5/04

(52) U.S. Cl. CPC G06Q 30/0631; G06Q 30/0641; G06N 5/04; G06F 16/9535

(57) ABSTRACT

Provided is a method for dynamically displaying product features related to cognitive customer relevant preferences. The method comprises obtaining user data relevant to user preferences regarding product features. The method further comprises generating a ranking of the product features using the obtained user data. The method further comprises generating a user preference profile based on the ranking of the product features. The method further comprises obtaining product data and applying the user preference profile to the obtained product data to generate relevant product content. The method further comprises displaying the relevant product content.

### BACKGROUND

The present disclosure relates generally to the field of artificial intelligence, and more particularly to dynamic displays of product features that are related to cognitive customer relevant preferences.

Product features are variable characteristics of goods or services that are available for purchase. Such features or characteristics are utilized by a consumer to inform the selection of a particular good or service from a group of goods or services.

### SUMMARY

Embodiments of the present disclosure include a method, computer program product, and system for dynamically displaying product features related to customer relevant preferences. The method comprises obtaining user data relevant to user preferences regarding product features. The method further comprises generating a ranking of the product features using the obtained user data. The method further comprises generating a user preference profile based on the ranking of the product features. The method further comprises obtaining product data and applying the user preference profile to the obtained product data to generate relevant product content. The method further comprises displaying the relevant product content.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1A depicts a schematic view of an example webpage displaying product features for a particular product, in accordance with embodiments of the present disclosure.

FIG. 1B depicts the schematic view of the example website page of FIG. 1A with example eye-tracking data overlaid thereon, in accordance with embodiments of the present disclosure.

FIG. 2A depicts a schematic view of an example webpage displaying product features for several products, in accordance with embodiments of the present disclosure.

FIG. 2B depicts a schematic view of an example webpage displaying product features for the several products shown in FIG. 2A, wherein the displayed product features are based on the eye-tracking data shown in FIG. 1B, in accordance with embodiments of the present disclosure.

FIG. 3 illustrates a flowchart of an example method for dynamically displaying product features related to cognitive customer relevant preferences, in accordance with embodiments of the present disclosure.

FIGS. 4A-4D depict examples of product features at various stages in the performance of the method shown in FIG. 3, in accordance with embodiments of the present disclosure.

FIG. 5 depicts an example of product data at one stage in the performance of the method shown in FIG. 3, in accordance with embodiments of the present disclosure.

FIG. 6 depicts an example of relevant product characteristics at one stage in the performance of the method shown in FIG. 3, in accordance with embodiments of the present disclosure.

FIG. 7 depicts an example of relevant product content at one stage in the performance of the method shown in FIG. 3, in accordance with embodiments of the present disclosure.

FIG. 8 depicts an example of a display generated according to the method shown in FIG. 3, in accordance with embodiments of the present disclosure.

FIG. 9 illustrates a high-level block diagram of an example computer system that may be used in implementing one or more of the methods, tools, and modules, and any related functions, described herein, in accordance with embodiments of the present disclosure.

FIG. 10 depicts a cloud computing environment, in accordance with embodiments of the present disclosure.

FIG. 11 depicts abstraction model layers, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the invention.

### DETAILED DESCRIPTION

Aspects of the present disclosure relate generally to the field of artificial intelligence, and more particularly to dynamic displays of product features that are related to cognitive customer relevant preferences. While the present disclosure is not necessarily limited to such applications, various aspects of the disclosure may be appreciated through a discussion of various examples using this context.

When a consumer wants to purchase a product, some features of the product will typically be of higher relevance or importance to the consumer than other features. As used herein, a “consumer” refers to a person or entity who is considering purchasing a product either as an end-user of the product or as an intermediary provider of the product to an end-user. As used herein, a “product” refers to a good or a service that is available to be purchased by a consumer. A product may include, for example, a recipe, an article of clothing, a personal electronic device, a salon service, or commercial airline flights. These products are listed as non-limiting examples only. As used herein, a “feature” of a product refers to a variable characteristic of the product such as, for example, the ingredients, color, size, price, or schedule availability. The relative importance of a product's features may be ranked by the consumer, either consciously or sub-consciously. For example, a consumer may be aware that the size of a product he is purchasing is important, and therefore consciously prioritize that feature. Additionally, or alternatively, a consumer may not realize that he is drawn to products having a certain color, and therefore sub-consciously prioritize that feature.

Prioritized product features may vary from consumer to consumer and/or based on the intended use of the product. For example, some consumers may browse a self-select portal, such as an e-commerce website, to make their own purchases. In contrast, some consumers may be customer service representatives browsing through products on end-consumers' behalves. Moreover, each consumer may prioritize a different feature or features of a product than another consumer. Furthermore, the same consumer may prioritize different features for different products or even prioritize different features for the same product that has different intended uses.

One way for consumers to view available products is over the internet, for example on a website or application. It is common for a website to provide a list of specifications, or product features, for available products. However, this list of product features is typically organized and presented in a static manner. Accordingly, all consumers typically receive the same product feature information presented in the same format. Because consumers do not prioritize product features in a consistent manner, consumers may have to search through information that is unnecessary, uninteresting, or unimportant to them about a product to find the specific information in which they are interested. Sifting through information in this manner can be inefficient, frustrating, and/or confusing to a consumer.

Embodiments of the present disclosure may overcome the above, and other, problems by dynamically displaying product features related to cognitive customer relevant preferences. According to some embodiments of the present disclosure, a dynamic display unit may be configured to detect a consumer's preferences by collecting and interpreting the consumer's behaviors from various sources, such as for example, their internet of things (IoT) data, mobile device interactions, social media interactions, and website shopping experiences. IoT data may include, for example, applications and/or software installed, viewed metrics, and context derivation, such as search terms. These sources are listed as non-limiting examples only. More specifically, the dynamic display unit may be configured to detect a consumer's preferences using eye-tracking, user profile information, purchase history, product reviews, product search criteria, and activities on social platforms. Eye-tracking may include, for example, information regarding what the consumer is viewing during searches and/or engagement in other activities as well as historical usage of the eye tracking abilities and pattern recognition thereof. User profile information may include, for example, the location, values, and/or interests of the consumer. Purchase history may include, for example, previous purchases made by the consumer as well as similarities or patterns in features of previous purchases. Product reviews may include, for example, what the consumer considers to be an important feature. Activities on social platforms may include, for example, likes, friends, and/or content of posts on social media. These behaviors are listed as non-limiting examples only. The dynamic display unit may further be configured to interpret the consumer's behaviors in a cognitive way to arrive at insightful data specific to that consumer. Such data may then be used to customize the consumer's view of product details and features.

For example, the dynamic display unit may be configured to display important product features in a prominent way. In some embodiments, the dynamic display unit may be configured to display important product features in a separate group, label the group “important for you,” and/or arrange the group first, at the top of the display. Additionally, or alternatively, the dynamic display unit may be configured to indicate why particular features have been selected and prominently displayed to the consumer. Additionally, or alternatively, the dynamic display unit may be configured to sequence product images according to those product features which have been determined to be important such that images displaying the important features of the product are most easily viewable.

It is to be understood that the aforementioned advantages are example advantages and should not be construed as limiting. Embodiments of the present disclosure can contain all, some, or none of the aforementioned advantages while remaining within the spirit and scope of the present disclosure.

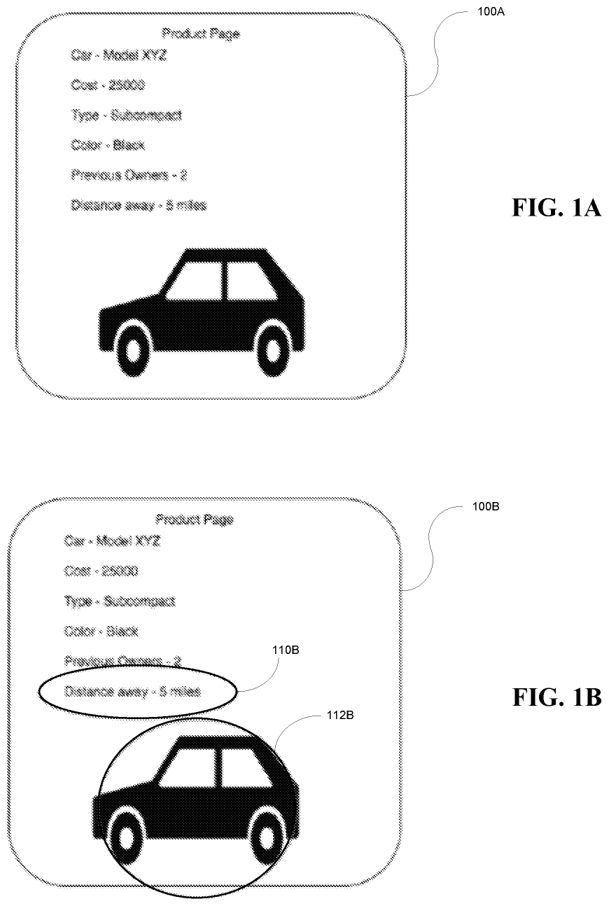

As shown in FIGS. 1A and 1B, in some embodiments of the present disclosure, eye-tracking may be used to detect a consumer's preferences. As shown in FIG. 1A, a default product page 100A for a car that is for sale may include information pertaining to several features of the car such as model, price, type, color, number of previous owners, distance from the consumer, and a photo or image of the car. As shown in FIG. 1B, using eye-tracking as the consumer views the default product page 100B, the dynamic display unit (not shown) may detect areas of the product page on which the consumer is most focused based on how much time the consumer's eyes spend on those areas. These focus areas, for example focus areas 110B and 112B in FIG. 1B, indicate which features of the product the consumer is most interested in. Accordingly, in the example shown in FIG. 1B, the consumer is focusing the most attention on the distance of the car from the consumer, as indicated by focus area 110B, and the photo of the car, as indicated by focus area 112B. Therefore, eye-tracking may be used to detect the consumer's preferences for these product features.

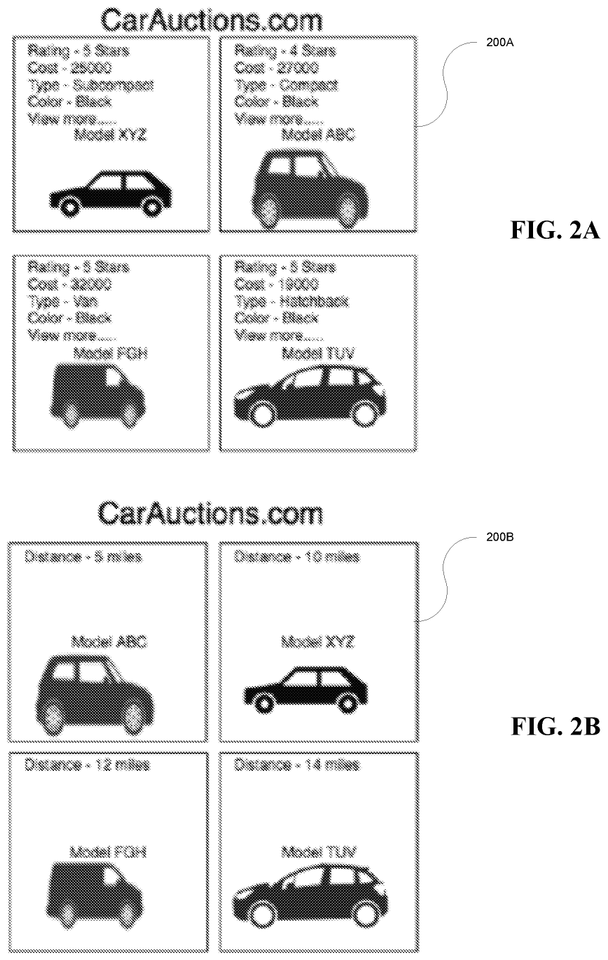

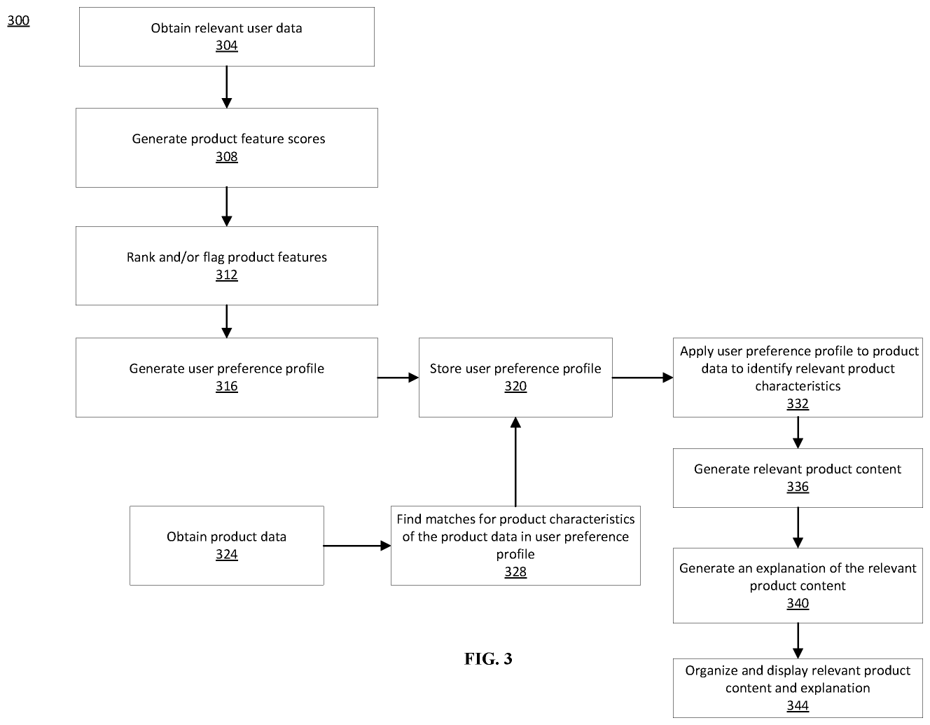

As shown in FIGS. 2A and 2B, the dynamic display unit may then use this eye-tracking data to customize the product features that are displayed to the consumer. FIG. 2A shows a schematic drawing of a default webpage 200A where a consumer may browse or shop for a car. As shown in FIG. 2A, the default webpage includes information pertaining to several features of each car. However, not all of this information may be important to the consumer. FIG. 2B, in contrast, shows a webpage 200B generated by the dynamic display unit using the eye-tracking data illustrated in FIG. 1B. As shown in FIG. 2B, because the dynamic display unit has detected that the consumer focused the most attention on the distance from the consumer and the photo of the car, the dynamic display unit prioritizes that information in the display. In the embodiment shown in FIG. 2B, the dynamic display unit has displayed the items indicating the distance of the car from the consumer, the model, and the photo of the car. In some embodiments, other information pertaining to features of the car may be hidden, minimized, or shown less prominently. In some embodiments, the dynamic display unit may also display an explanation regarding which information has been selected to be prominently displayed and why.

Turning now to FIG. 3, an example method 300 for dynamically displaying product features related to cognitive customer relevant preferences is depicted, in accordance with embodiments of the present disclosure. Consistent with various embodiments of the present disclosure, such as the examples shown in FIGS. 1A-2B, the method 300 may be used to dynamically determine what information is pertinent to a particular consumer and/or for a particular purchase. The method 300 may also be used to dynamically determine how the information will be displayed to the consumer. The method 300 may be performed by a dynamic display unit, which may be embodied as hardware, firmware, software executing on a processor, a processor, or any combination thereof. For example, the method 300 may be performed by a dynamic display unit that includes a memory and a processor.

The method 300 may begin at step 304, wherein a consumer, also referred to herein as a user, enables relevant data to be obtained. As used herein, the term “relevant data” refers to consumer data which can be used by the dynamic display unit to generate a dynamic display of product features. The consumer can agree to have relevant data collected from one or more sources to be utilized in dynamically displaying product features related to his relevant preferences with the goal of improving his retail experience. Dynamically displaying product features may be particularly useful, for example, for a consumer searching for a product in a product category wherein the products have a large number of variable product features. In some embodiments, the consumer may agree to have relevant data collected by a separate application which then communicates with a retailer's user interface. Alternatively, in some embodiments, the consumer may agree to have relevant data collected by a retailer's user interface.

As mentioned above, the one or more sources for relevant data collection may include, for example: IoT data, including mobile device interactions; customer profile information, including location, preferences, demographic information, etc.; customer order history; customer product reviews; customer activities on social media platforms; product search criteria; and eye-focus tracking. By agreeing to have his relevant data collected, the consumer enables the dynamic display unit to collect data and analyze or interpret that data to generate a dynamic display of product features.

In at least one embodiment, the dynamic display unit may be configured to implement the IBM Tealeaf® Customer Experience, which is an analytics solution for web and mobile applications. The IBM Tealeaf Customer Experience enables capturing data for individual user sessions to determine what content is valuable. It is to be understood that IBM Tealeaf Customer Experience is an example analytics platform, and that other analytics platforms for capturing and analyzing user data to determine which content is valuable to the user (e.g., using eye tracking) may be used in embodiments of the present disclosure.

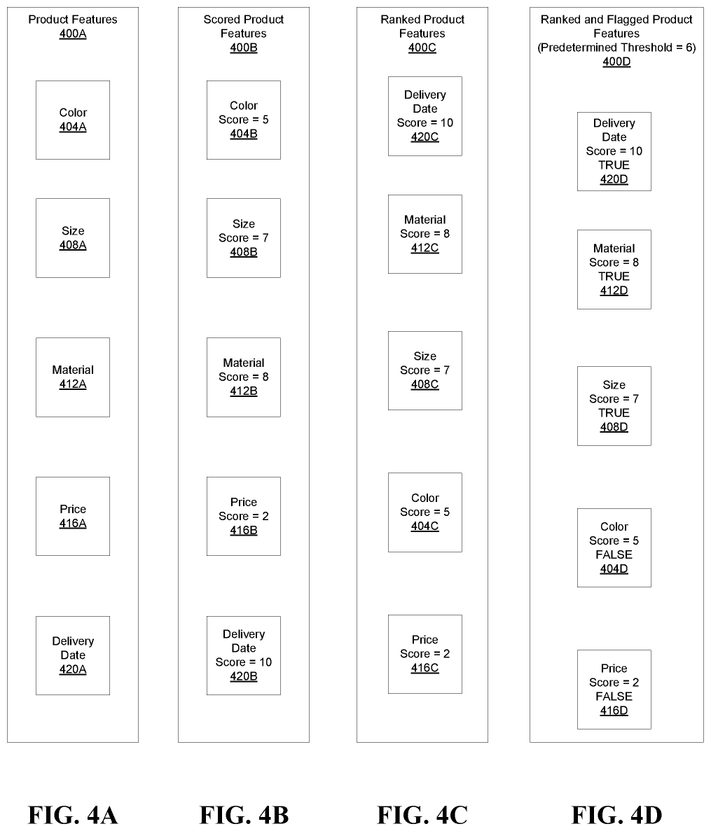

By way of example, FIG. 4A depicts a number of product features 400A, which have been identified by the dynamic display unit in the course of obtaining the relevant user data. As shown in FIG. 4A, the dynamic display unit has collected relevant user data related to product color 404A, size 408A, material 412A, price 416A, and delivery date 420A. More specifically, the dynamic display unit may have obtained relevant user data from the consumer's social media posts indicating that the consumer plans to use the desired product for an upcoming event on a particular date. The dynamic display unit associates this relevant user data with the delivery date 420A product feature.

Returning to FIG. 3, once the relevant user data is obtained, the method 300 may proceed with step 308 in which at least one algorithm is applied to the data to generate one or more product feature score(s). In some embodiments, the dynamic display unit may be configured to apply a weighting algorithm to the obtained relevant data to generate a product feature score for each product feature. For example, the dynamic display unit may be configured to consider the data source as well as the context of the data within a confidence and correlation value from machine learning to generate the product feature score(s). In some embodiments of the present disclosure, machine learned details surrounding product features and the correlation of those details to the consumer choice may be derived by considering a given amount of statistical significance after algorithm processing.

As shown in FIG. 4B, in the given example, application of the at least one algorithm to the user data in step 308 of the method 300 generates scored product features 400B. In particular, the dynamic display unit generates a product feature score of 5 for color 404B, a product feature score of 7 for size 408B, a product feature score of 8 for material 412B, a product feature score of 2 for price 416B, and a product feature score of 10 for delivery date 420B.

As discussed above, the dynamic display unit generates each product feature score based on the obtained relevant user data. For example, as discussed above, the dynamic display unit may have generated the product feature score of 10 for delivery date 420B based on relevant user data obtained from the consumer's social media posts regarding the intended use of the desired product at an event on a particular date, indicating that having the product by that date, or the delivery date, is of high importance to the consumer. Similarly, the dynamic display unit may have generated the product feature score of 8 for material 412B based on relevant user data obtained from the consumer's previous purchase history regarding the consumer's consistency in choosing products made of a particular material.

Returning to FIG. 3, following the application of the at least one algorithm to the user data and the generation of product feature score, the method 300 may proceed with step 312, wherein various product features are ranked by their product feature score and/or given a true/false flag depending on whether they meet a predetermined score threshold. In some embodiments, for example, a higher product feature score indicates that a product feature is of greater importance to the consumer. Whether the product feature score meets the predetermined threshold indicates whether or not the feature is important enough to be considered by the consumer.

As shown in FIG. 4C, in the given example, the dynamic display unit ranks the scored product features to generate ranked product features 400C. The ranking of the product feature scores in the present example indicates that the product features in order from greatest to least importance to the consumer are: delivery date 420C, material 412C, size 408C, color 404C, and price 416C.

As shown in FIG. 4D, in the given example, each of the product features is given a TRUE/FALSE flag depending on whether its product feature score meets the predetermined threshold. The dynamic display unit generates ranked and flagged product features 400D according to the ranking determined at step 312. More specifically, if a product feature score meets the predetermined threshold, it is labeled with a TRUE flag, and if a product feature score does not meet the predetermined threshold, it is labeled with a FALSE flag. In some alternative embodiments of the present disclosure, the dynamic display unit may flag product features without ranking them. In some embodiments, the predetermined threshold may be the same for all product feature scores. In some alternative embodiments, the predetermined threshold may be different for each product feature.

FIG. 4D shows a result of an embodiment of the present example in which each of the product features is given a TRUE/FALSE flag depending on whether the product feature score for that feature met a predetermined threshold, wherein the predetermined threshold for all product features was 6. Accordingly, as shown, because the product feature score for the price 416D was 2, the product feature did not meet the predetermined threshold and was labeled with a FALSE flag. Similarly, the product feature score for the color 404D was 5, which failed to meet the predetermined threshold, and the product feature was therefore labeled with a FALSE flag. Accordingly, based on the FALSE flags, the dynamic display unit determines that price and color are unimportant to the consumer. In contrast, the product feature scores for the size (408D), the material (412D), and the delivery date (420D) all meet the predetermined threshold, and therefore each of the size, material, and delivery date product features is marked with a TRUE flag, indicating that those product features are important to the consumer.

Returning to FIG. 3, once the product features have been ranked and/or flagged based on their product feature scores, the method 300 may proceed to step 316, wherein the product feature rankings and/or flags are used to generate a user preference profile. The user preference profile may include the consumer's product feature preferences as indicated by product feature scores, rankings, and flags. In some embodiments of the present disclosure, the term “consumer's product feature preferences” refers to the features which the consumer considers to be important or relevant. More specifically, the consumer's product feature preferences indicate, for example, how important, if at all, the consumer considers the color of a product to be, rather than which variant of that feature is preferred, for example, if the consumer prefers the color red over blue. In alternative embodiments of the present disclosure, the consumer's product feature preferences may include which variants of product features the consumer considers to be important or relevant in addition to, or instead of, which product features the consumer considers to be important or relevant. In some embodiments, the user preference profile may be regularly updated based on newly collected relevant user data. For example, the user preference profile may be continuously updated or may be updated repeatedly at regular intervals. Once the user preference profile has been generated, the method 300 may proceed to step 320, wherein the user preference profile is stored in a computer-readable storage medium.

The method 300 further includes, at step 324, obtaining product data. As used herein, “product data” refers to information about the goods or services in which the consumer is interested which can be used by the dynamic display unit to generate a dynamic display of product features. In other words, the product data may include product features and variants of product features for a given product. Product data may be obtained by the dynamic display unit for each of the available goods or services which the consumer is choosing between. The product data may be obtained from, for example, e-commerce websites.

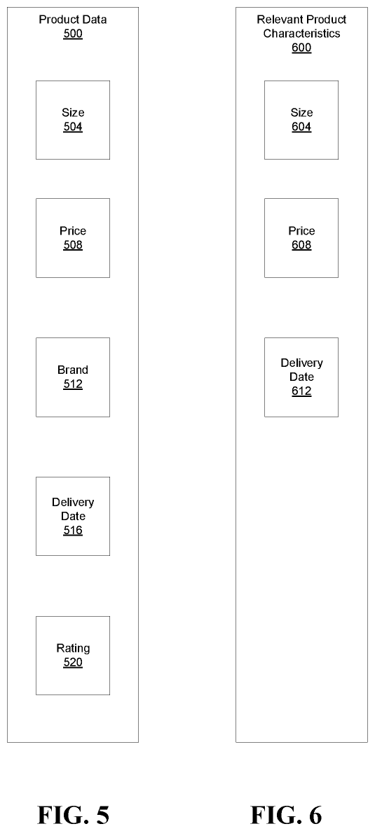

As shown in FIG. 5, in the present example, the product data 500 for products in which the consumer may be interested may include the size 504, price 508, brand 512, delivery date 516, and rating 520 of that item. Accordingly, the dynamic display unit may be configured to obtain the color, size, brand, shipping date, and rating of each item in the group or category in which the consumer is interested.

Returning to FIG. 3, once the product data has been obtained, the method 300 may proceed to step 328, wherein the computer-readable storage medium is queried to find matches for product characteristics of the product data in the user preference profile. In other words, in step 328, the dynamic display unit searches the user preference profile to determine whether product features from the available product data match the consumer's product feature preferences. As shown in FIG. 3, to find matches, the user preference profile that was stored in the computer-readable storage medium at step 320 is queried.

Steps 324 and 328 of the method 300 may be occurring simultaneously with steps 308-320, or they may occur sequentially following steps 308-320. In embodiments wherein the user preference profile is continuously or regularly updated, the dynamic display unit may obtain product data and query the computer-readable storage medium contemporaneously or overlapping in time with the performance of steps 308-320. It is to be understood, however, that in order for step 328 to be performed, there must be a user preference profile stored in the computer-readable storage medium to be queried.

As shown in FIG. 3, once the user preference profile stored in the computer readable storage medium has been queried, the method 300 may proceed to step 332, wherein the user preference profile is applied to the obtained product data to identify relevant product characteristics. As used herein, the term “relevant product characteristics” refers to those product characteristics or features in the obtained product data which have been determined by the dynamic display unit, based on the product feature rankings and flags, as being important to the consumer.

Continuing with the example from above, as shown in FIG. 6, the relevant product characteristics 600 are those product features (500 in FIG. 5) included in the product data that were also identified as product features (400A in FIG. 4A) identified by the dynamic display unit in the course of obtaining relevant user data. In other words, by applying the user preference profile to the obtained product data, the relevant product characteristics 600 are identified. As shown, the relevant product characteristics 600 include size 604, price 608, and delivery date 612.

Returning to FIG. 3, once the dynamic display unit has identified the relevant product characteristics, the method 300 may then proceed to step 336, wherein the relevant product characteristics are selected from the product data to generate relevant product content. As used herein, “relevant product content” refers to information associated with the variants of the product features which have been determined to be relevant to the consumer and will therefore be displayed to the consumer to aid in the consumer's decision making.

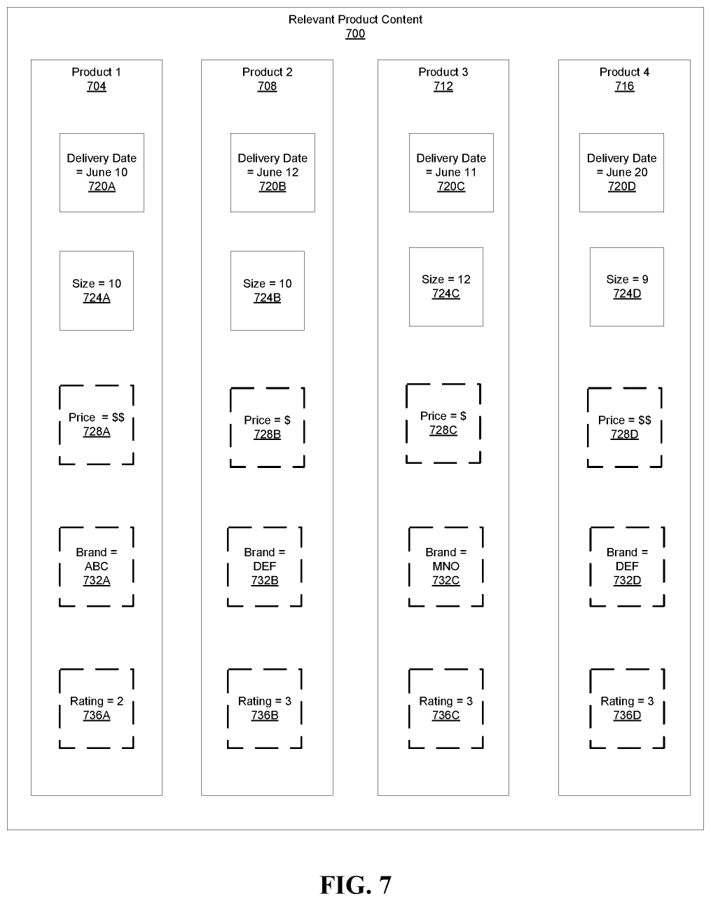

As shown in FIG. 7, the relevant product content 700 includes information associated with the variants of product features of each of four available products: 704, 708, 712, and 716. In particular, the delivery date and size product features are selected to generate relevant product data. Accordingly, the dynamic display unit generates relevant product data using the delivery dates 720A, 720B, 720C, and 720D and sizes 724A, 724B, 724C, and 724D of the products 704-716, respectively. In the present example embodiment, the price product feature was not labeled with a TRUE flag. As such, price was not determined to be a relevant product feature to the consumer. Thus, as shown in FIG. 7, price is not a product feature selected to generate relevant product data. To indicate this status, the prices 728A, 728B, 728C, and 728D of the products 704-716 are shown with dashed lines in FIG. 7. Similarly, because brand and rating were not indicated as being relevant product features to the consumer, the brands 732A, 732B, 732C, and 732D and the ratings 736A, 736B, 736C, and 736D of the products 704-716 are not selected to generate relevant product data, and are also shown with dashed lines in FIG. 7.

In some alternative embodiments of the present disclosure, the relevant product content will include information associated with the variants of the price product feature, because even though the price product feature was not labeled with a TRUE flag, it was included in the product features that were generated based on the relevant user data, and was also provided in the product data.

Returning to FIG. 3, once the dynamic display unit has selected relevant product characteristics to generate relevant product content, the method 300 may then proceed to step 340, wherein at least one explanation of the relevant product content is generated based on the user preference profile. For example, it may be useful to provide the consumer with an explicit description of why variants of certain product features were used to generate the relevant product content presented to the consumer while others were not, especially in instances of sub-conscious user preferences. In some embodiments, an explanation may be generated for each product feature that was used to generate the relevant product content. Additionally, or alternatively, in some embodiments of the present disclosure, an explanation may be generated for each product feature that was not used to generate the relevant product content. The generation and provision of such explanations may also be useful if the consumer desires to override or modify the relevant product content that is displayed to the consumer.

In step 344 of the method 300, the dynamic display unit organizes and displays the relevant product content and explanations. For instance, as shown in the example of FIG. 2B, the dynamic display unit may sequence the available products based on the user preference profile such that products perceived to be of the most interest to the consumer are most readily visible. Additionally, the dynamic display unit may only cause the relevant product content to be displayed.

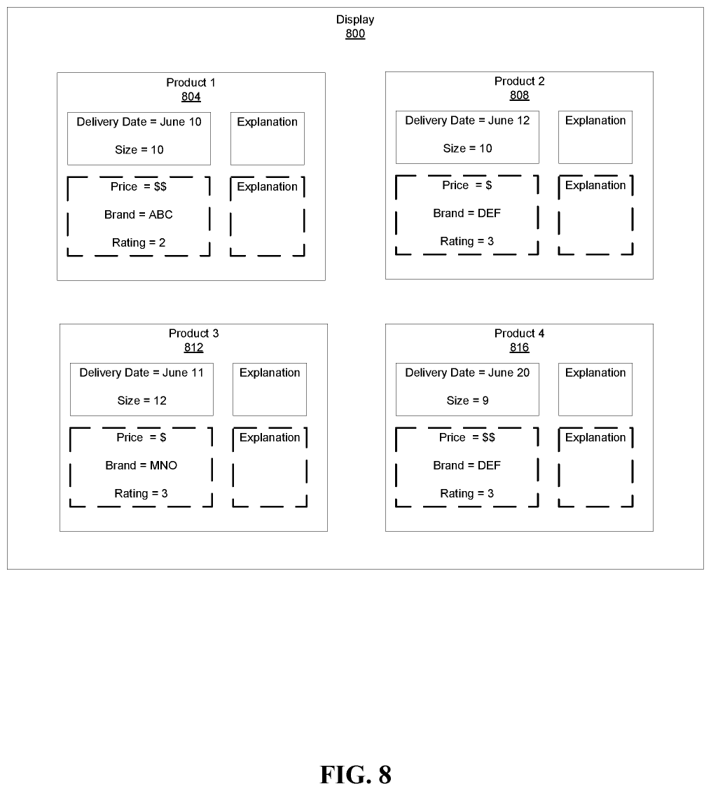

Alternatively, or additionally, in some embodiments of the present disclosure, the dynamic display unit may cause the relevant product content to be grouped, highlighted, or emphasized relative to additional product data that was not determined to be relevant product content. For example, as shown in FIG. 8, the dynamic display unit has organized the relevant product content and associated explanations for each of the four products 804, 808, 812, and 816 in the display 800. Other product characteristics, such as price, and other product data, such as brand and rating, may be displayed in the display 800, and may be accompanied by respectively associated explanation(s). In the example shown in FIG. 8, the products 804-816 are not sequenced based on the variants of the relevant product content. Instead, the product features in which the dynamic display unit has determined the consumer is most interested are prioritized and emphasized. In alternative embodiments, however, it is possible for the dynamic display unit to consider which variant of each product feature the consumer prefers and to further organize and display the relevant product content and explanations based on that information.

By organizing and displaying the relevant product content and explanations, the dynamic display unit enables consumers to find the specific information about a product or products in which they are interested without searching through information about the product or products that is unnecessary, uninteresting, or unimportant to them.

In some alternative embodiments of the present disclosure, the method 300 may not include step 340, such that the method 300 does not include generating an explanation of the relevant product content based on the user preference profile. Accordingly, in such embodiments, step 344 does not include organizing and displaying explanations of relevant product content. Instead, in such embodiments, step 344 only includes organizing and displaying relevant product content.

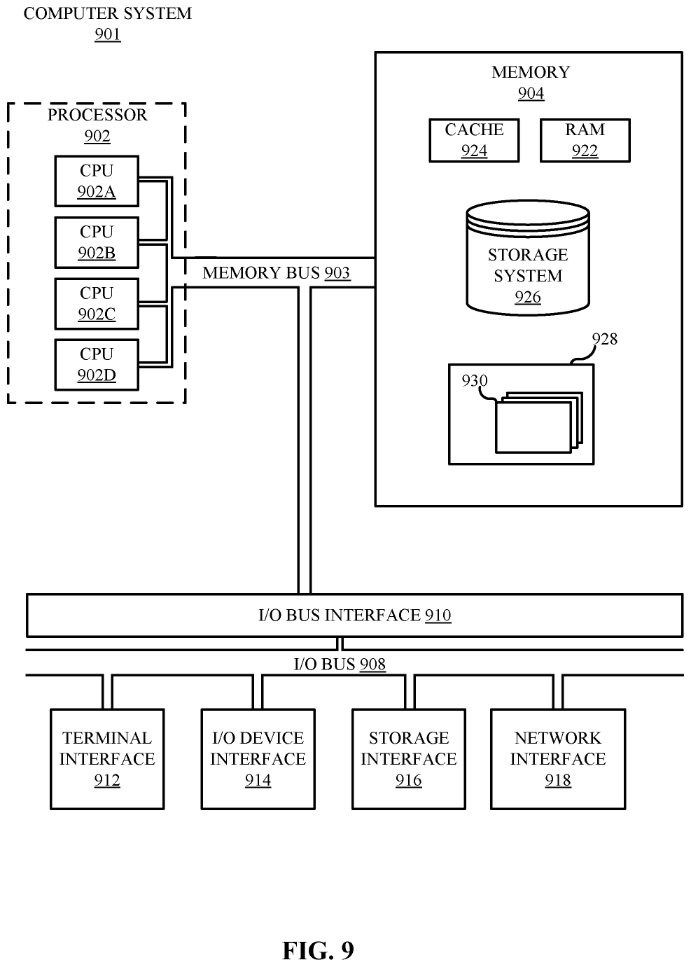

Referring now to FIG. 9, shown is a high-level block diagram of an example computer system 901 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 901 may comprise one or more CPUs 902, a memory subsystem 904, a terminal interface 912, a storage interface 916, an I/O (Input/Output) device interface 914, and a network interface 918, all of which may be communicatively coupled, directly or indirectly, for inter-component communication via a memory bus 903, an I/O bus 908, and an I/O bus interface unit 910.

The computer system 901 may contain one or more general-purpose programmable central processing units (CPUs) 902A, 902B, 902C, and 902D, herein generically referred to as the CPU 902. In some embodiments, the computer system 901 may contain multiple processors typical of a relatively large system; however, in other embodiments the computer system 901 may alternatively be a single CPU system. Each CPU 902 may execute instructions stored in the memory subsystem 904 and may include one or more levels of on-board cache.

System memory 904 may include computer system readable media in the form of volatile memory, such as random access memory (RAM) 922 or cache memory 924. Computer system 901 may further include other removable/non-removable, volatile/non-volatile computer system storage media. By way of example only, storage system 926 can be provided for reading from and writing to a non-removable, non-volatile magnetic media, such as a “hard drive.”

Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 904 can include flash memory, e.g., a flash memory stick drive or a flash drive. Memory devices can be connected to memory bus 903 by one or more data media interfaces. The memory 904 may include at least one program product having a set (e.g., at least one) of program modules that are configured to carry out the functions of various embodiments.

One or more programs/utilities 928, each having at least one set of program modules 930 may be stored in memory 904. The programs/utilities 928 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Program modules 930 generally perform the functions or methodologies of various embodiments.

Although the memory bus 903 is shown in FIG. 9 as a single bus structure providing a direct communication path among the CPUs 902, the memory subsystem 904, and the I/O bus interface 910, the memory bus 903 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 910 and the I/O bus 908 are shown as single respective units, the computer system 901 may, in some embodiments, contain multiple I/O bus interface units 910, multiple I/O buses 908, or both. Further, while multiple I/O interface units are shown, which separate the I/O bus 908 from various communications paths running to the various I/O devices, in other embodiments some or all of the I/O devices may be connected directly to one or more system I/O buses.

In some embodiments, the computer system 901 may be a multi-user mainframe computer system, a single-user system, or a server computer or similar device that has little or no direct user interface, but receives requests from other computer systems (clients). Further, in some embodiments, the computer system 901 may be implemented as a desktop computer, portable computer, laptop or notebook computer, tablet computer, pocket computer, telephone, smart phone, network switches or routers, or any other appropriate type of electronic device.

It is noted that FIG. 9 is intended to depict the representative major components of an exemplary computer system 901. In some embodiments, however, individual components may have greater or lesser complexity than as represented in FIG. 9, components other than or in addition to those shown in FIG. 9 may be present, and the number, type, and configuration of such components may vary.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

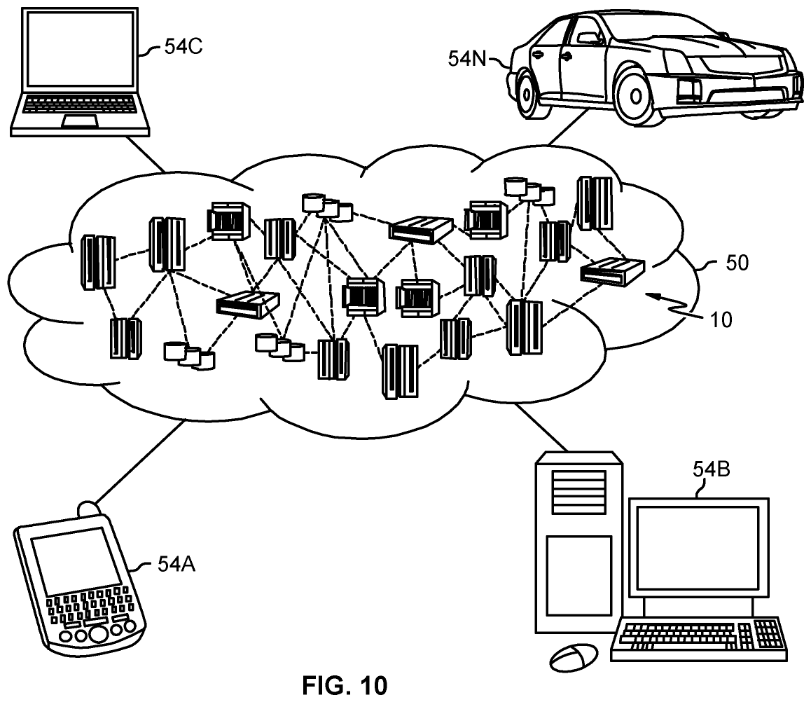

Referring now to FIG. 10, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-54N shown in FIG. 10 are intended to be illustrative only and that computing nodes 10 and cloud computing environment 50 can communicate with any type of computerized device over any type of network and/or network addressable connection (e.g., using a web browser).

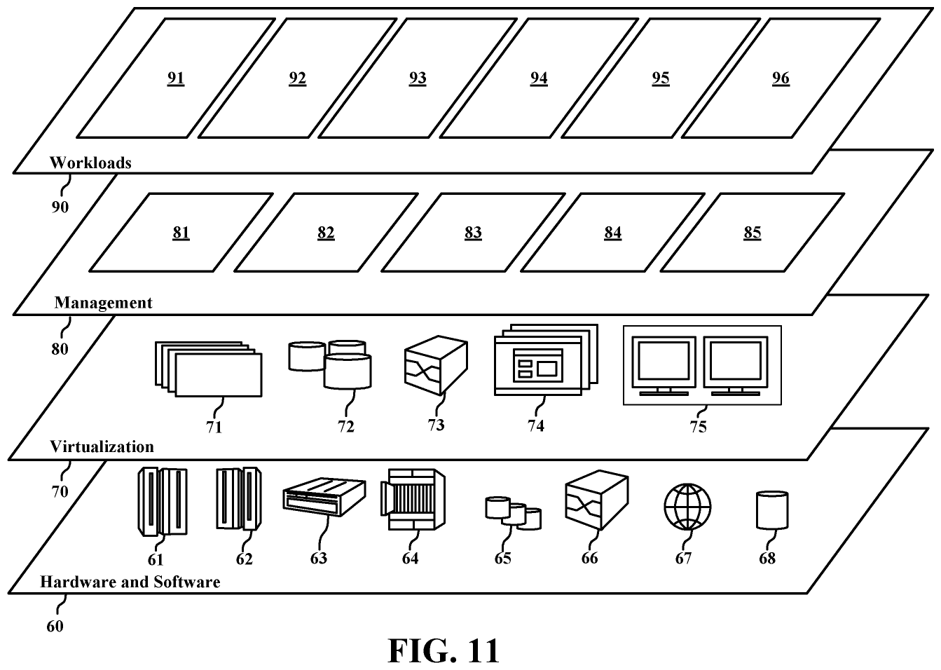

Referring now to FIG. 11, a set of functional abstraction layers provided by cloud computing environment 50 (FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktops 96.

In addition to embodiments described above, other embodiments having fewer operational steps, more operational steps, or different operational steps are contemplated. Also, some embodiments may perform some or all of the above operational steps in a different order. Furthermore, multiple operations may occur at the same time or as an internal part of a larger process. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

As used herein, “a number of” when used with reference to items, means one or more items. For example, “a number of different types of networks” is one or more different types of networks.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the invention.

What is claimed is:

1. A method, comprising:
obtaining user data relevant to user preferences regarding product features;
generating a ranking of the product features using the obtained user data;
generating a user preference profile based on the ranking of the product features;
obtaining product data;
applying the user preference profile to the obtained product data to generate relevant product content; and
displaying the relevant product content.

2. The method of claim 1, wherein obtaining user data includes obtaining eye-tracking data of a user operating an electronic device.

3. The method of claim 1, wherein:
the obtained product data includes product characteristics; and
applying the user preference profile includes selecting some portion of the product characteristics.

4. The method of claim 3, wherein selecting some portion of the product characteristics includes identifying which product characteristics are included in the ranking of the product features.

5. The method of claim 1, wherein displaying the relevant product content includes organizing the relevant product content based on the user preference profile.

6. The method of claim 1, further comprising:
generating an explanation of the relevant product content based on the user preference profile.

7. The method of claim 6, wherein displaying the relevant product content includes displaying the explanation.

8. A computer program product comprising a computer readable storage medium having program instructions embodied therewith, the program instructions executable by processor to cause the processor to perform a method comprising:
obtaining user data relevant to user preferences regarding product features;
generating a ranking of the product features using the obtained user data;
generating a user preference profile based on the ranking of the product features;
obtaining product data;
applying the user preference profile to the obtained product data to generate relevant product content; and
displaying the relevant product content.

9. The computer program product of claim 8, wherein obtaining user data includes obtaining eye-tracking data of a user operating an electronic device.

10. The computer program product of claim 8, wherein:
the obtained product data includes product characteristics; and
applying the user preference profile includes selecting some portion of the product characteristics.

11. The computer program product of claim 10, wherein selecting some portion of the product characteristics includes identifying which product characteristics are included in the ranking of the product features.

12. The computer program product of claim 8, wherein displaying the relevant product content includes organizing the relevant product content based on the user preference profile.

13. The computer program product of claim 8, further comprising:
generating an explanation of the relevant product content based on the user preference profile.

14. The computer program product of claim 13, wherein displaying the relevant product content includes displaying the explanation.

15. A dynamic display unit comprising:
a memory; and
a processor communicatively coupled to the memory, wherein the processor is configured to perform a method comprising:
obtaining user data relevant to user preferences regarding product features;
generating a ranking of the product features using the obtained user data;
generating a user preference profile based on the ranking of the product features;
obtaining product data;
applying the user preference profile to the obtained product data to generate relevant product content; and
displaying the relevant product content.

16. The dynamic display unit of claim 15, wherein obtaining user data includes obtaining eye-tracking data of a user operating an electronic device.

17. The dynamic display unit of claim 15, wherein:
the obtained product data includes product characteristics; and
applying the user preference profile includes selecting some portion of the product characteristics.

18. The dynamic display unit of claim 17, wherein selecting some portion of the product characteristics includes identifying which product characteristics are included in the ranking of the product features.

19. The dynamic display unit of claim 15, wherein displaying the relevant product content includes organizing the relevant product content based on the user preference profile.

20. The dynamic display unit of claim 15, further comprising:
generating an explanation of the relevant product content based on the user preference profile.
